(19) United States
(12) Patent Application Publication
(10) Pub. No.: US 2006/0243509 A1
(43) Pub. Date: Nov. 2, 2006

(54) Low-lift industrial truck

(76) Inventors: Gunter Hellmann, Sievershutten (DE); Marcel Krenzin, Bad Bramstedt (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/373,371

(22) Filed: Mar. 10, 2006

(30) Foreign Application Priority Data
Mar. 31, 2005 (DE) 10 2005 014 907.3

(51) Int. Cl. B62K 13/00

(52) U.S. Cl. 180/209

(57) ABSTRACT

A low-lift industrial truck, comprising a drive portion having a driving axle and a load-carrying portion which has two parallel wheel arms and is adjustable in height by means of a lifting device, wherein the wheel arms have load-carrying wheels in the free end region that are supported in rocker arms which, in turn, are coupled to the drive portion via a linkage so as to pivot the load-carrying wheels towards the underlying floor when the load-carrying portion is lifted, wherein the load-carrying portion has provided thereon an additional axle on which the load-carrying portion rests when in a lowered, non-loaded condition while the load-carrying wheels are largely relieved of loads or are lifted from the underlying floor.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Low-lift industrial trucks usually have wheel arms which form part of the chassis, on one hand, and define a load-carrying means, on the other. For this purpose, the wheel arms can be lifted by a certain amount by means of an appropriate lifting device in order to sufficiently lift pallets, which were picked up, from the floor and carry them to a desired target location. The load-carrying wheels mounted at the front ends of the wheel arms are supported in rocker arms—the so-called wheel arm levers—which, in turn, are coupled to the drive portion of the industrial truck via a linkage in order that if the load-carrying portion is lifted the load-carrying wheels may be pivoted towards the underlying floor, thus lifting the wheel arms nearly in parallel with the floor.

Wheel arm supported low-lift industrial trucks usually have two axles, i.e. the driving axles and the load-carrying axle. The driving axle comprises a steered driving wheel which, as an alternative, mates with one or two more lateral supporting rollers. A three-wheeled chassis is spoken of in the former case and a five-wheeled chassis in the latter case. The load-carrying axle is defined by the load-carrying front wheels.

It is necessary for the load-carrying wheels to run over cross timbers, depending on the direction of pick-up or type of a pallet. When floors are particularly smooth the problem which arises is that the pallet will be pushed along ahead of the vehicle and the load-carrying wheels cannot roll over the cross timber. Thus, the pallet which either is empty or only is loaded slightly can neither be picked up for transportation nor can be put down.

It is known to counteract such problem by providing drive-on skids at the underside of the wheel arms. It is also known to provide so-called climbing rollers in front of or behind the wheel arm ends which are intended to facilitate a run over the cross timbers. However, those provisions do not resolve the above problem in a satisfactory manner.

Therefore, it is the object of the invention to provide a low-lift industrial truck which allows to safely pick up pallets even if the underlying floor is smooth.

### BRIEF SUMMARY OF THE INVENTION

In the inventive low-lift industrial truck, the load-carrying portion has provided thereon an additional axle which is disposed between the drive portion and the ends of the wheel arms. The additional axle is used to support the wheel arms on the underlying floor when the load-carrying portion is in its fully lowered position and does not carry a load either. The arrangement of the additional axle is such that the whole vehicle tilts towards the driving axle via the additional axle in the case described and, thus, the load-carrying wheels will be largely relieved of loads or are slightly lifted above the underlying floor. Hence, a movement into or out of transversely slatted pallets does not pose a problem any longer. When the load-carrying portion is slightly lifted from the fully lowered position as is the case during a standard lifting function the load-carrying wheels which support the wheel arms will move out in a usual manner and lift the pallet freely from the floor. At the same time, the wheel or wheels of the additional axle will be lifted. Now, the low-lift industrial truck with a load picked up will have its driving-axle design load which it requires for starting, braking, and steering and. hence, it may be operated safely.

The factor determining the way of mounting the additional axis is the distance between the upper side of the lower slat and the lower side of the upper slat of the pallet. Care needs to be taken that the ends of the wheel arms, when in a lowered condition, can move in safely at this distance. Furthermore, it must be made sure that the upper side of the wheel arms exhibits a sufficient distance from the lower side of the upper slat in this case in order that the wheel of the additional axle is lifted from the floor at the beginning of the lift before the pallet is lifted. A further factor essential to the position of the additional axle is that the centre of gravity of the vehicle, when it is in a non-loaded condition, is located between the driving and additional axles.

According to an aspect of the invention, a provision is made for the additional axle to have at least one wheel if there is a four-wheeled chassis. The chassis has at least two wheels if there is a three-wheeled or five-wheeled chassis.

Apart from the need of installing the additional axle, an operation of the inventive industrial truck requires to make further provisions since the lift of the wheel arms can be adjusted on the industrial truck via appropriate control elements anyhow. However, according to a further aspect of the invention, it is possible to equip the additional axle with a separate lifting device, e.g. for putting the additional axle out of function or making it adjustable with respect to very different pallet geometries.

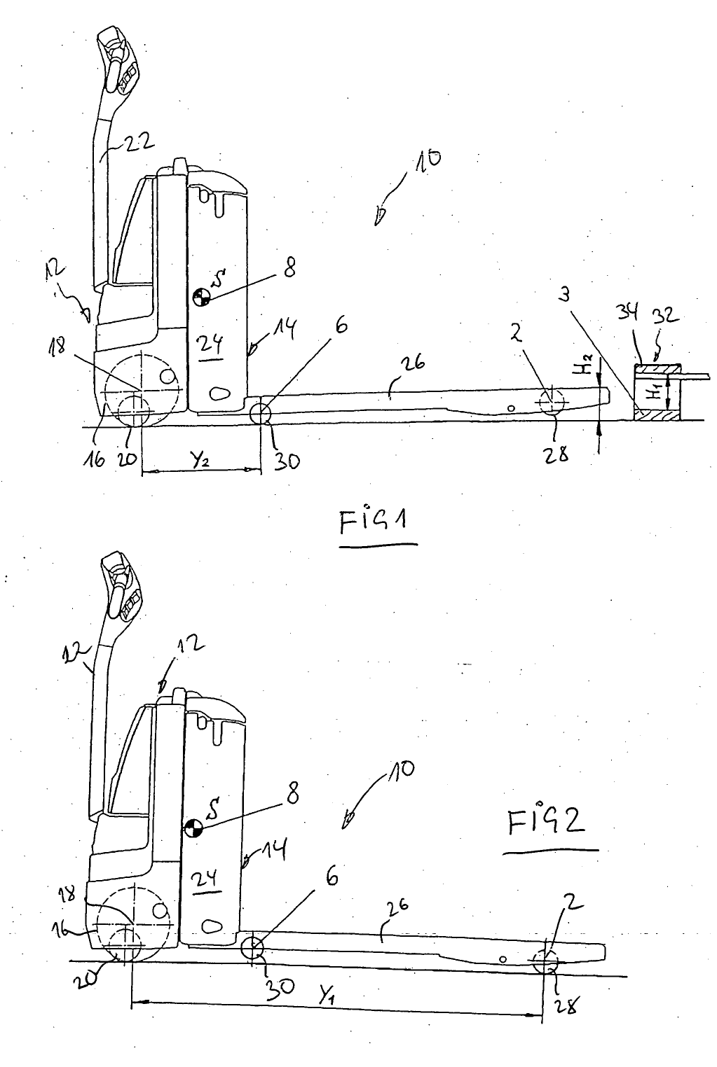

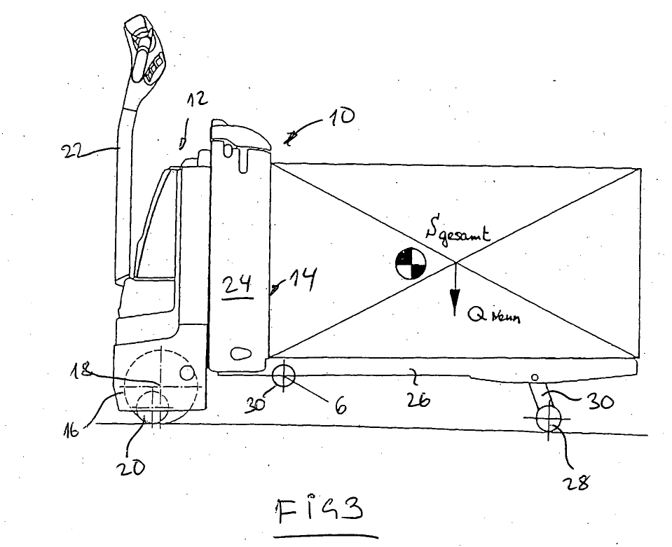

Another benefit of the invention is the exceedingly short distance Y2 between axles in driving with no load and the load-carrying portion in a lowered position (see FIG. 1) as compared to the distance Y2 between axles with the additional axle lifted freely (see FIG. 2). Those facts allow to maneuver and move into pallets in narrow passageways, particularly on the load platforms of trucks.

When the additional axle is positioned in the longitudinal vehicle direction in the vehicle's middle the smallest turning radius possible will even result.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

An embodiment of the invention will be described in more detail below with reference to the drawings:

FIG. 1 shows a low-lift industrial truck of the invention with the load-carrying portion in a fully lowered condition.

FIG. 2 shows the industrial truck of FIG. 1 with the load-carrying portion in a slightly lifted position.

FIG. 3 shows the industrial truck of FIGS. 1 and 2 with the load-carrying portion in an lifted position and a load picked up.

The low-lift industrial truck 10 illustrated in FIGS. 1 to 3 has a drive portion 12 and a load-carrying portion 14. The drive portion has a central steerable driving wheel 16 which defines the driving axle 18. Supporting rollers one of which can be recognized at 20 are laterally provided at either side of the driving wheel 16. The driving wheel 16 is steered in a known manner via a drawbar 22 on the head of which control elements (not described in detail) are provided. The drive portion 12 also accommodates the driving motor and the lifting device which are not shown, however.

The load-carrying portion 14 has a frame 24 in which a battery is also housed. The frame 24 is adjustably guided in height on the drive portion 12 and is adjusted in height by the lifting device between a fully lowered position as per FIG. 1 and a maximally lifted position as per FIG. 3.

The frame 24 of the load-carrying portion 14 has fixedly mounted thereon two parallel-spaced wheel arms one of which can be recognized at 26. The free ends regions of the wheel arms have disposed thereon load-carrying wheels arms one of which can be recognized at 28. As can be seen in FIG. 3 the load-carrying wheels 28 are supported by a rocker arm 30 which, in turn, is coupled to the drive portion via a linkage located in the wheel arms 26, which is not shown in detail, and in the frame 24 in such a way that if a shift is performed into an lifted position from the lowered position the load-carrying wheels 28 are lowered automatically via the rocker arm 30 in order to maintain a contact with the floor. This function also is generally known. The axle defined by the load-carrying wheels 28 is designated by 2 in FIGS. 1 and 2.

An additional axis 6 is provided close to the frame 24 that has at least one or two wheels 30, for example, depending on the chassis used for the industrial truck. As can be seen the centre of gravity 8 of the vehicle 10, when in a non-loaded condition, lies between the axles 18 and 6. As is further shown in FIG. 1 the wheel 30 rests on the underlying floor when the load-carrying portion 14 is fully lowered whereas the wheel arms 26 and load-carrying wheels 28 are slightly lifted. The beginning of a pallet which is not illustrated in greater detail is shown at 32 in FIG. 1. It allows to see a lower slat 3 and an upper slat 34. Therefore, it is necessary to overcome the lower slat 34 when the wheel arms 26 move into the pallet. The fact that the load-carrying wheels 28 are slightly above the floor allows the wheel arms to move into the pallet 342 without pushing them along ahead of the arms even if the underlying floor is smooth. This same naturally applies to an outward movement.

As can be further seen in FIG. 1 the height H2 of the upper sides of the wheel arms 26 is slightly below the lower side of the upper slat 34 (the distance between this lower side and the upper side of the lower slat 3 being designated by H1). It is understood that the upper side of the wheel arms 26, in a lowered condition, is slightly lower than is the lower side of the upper slat 34. Moreover, this distance requires to be dimensioned so as to liberate the wheel 30 of the additional axle 6 when the load-carrying portion 14 is lifted to a certain extent, on one hand, and the load-carrying wheels 28, when actuated via the linkage which is not shown, will get into contact with the floor. This makes it possible to lift the pallet from the floor.

The latter case is outlined in FIG. 3. Here, in a common manner, the centre of gravity again lies between the driving axle 18 and the axle of the load-carrying wheels 28 which are fully moved out with respect to the wheel arms 26.

In the case shown, the wheel 30 of the additional axle 6 is rigidly attached to the wheel arms 26 near the frame 24. It is also possible to arrange the wheel 30 and the additional axle 6 in an approximately central relationship within the vehicle. Also, the wheel 30 can be used to maneuvre the vehicle with the load-carrying portion 14 in a lowered position. This will allow the vehicle 10 to become maneuvrable particularly well because of the far smaller turning radius.

It is also conceivable to make the additional axle 6 adjustable in height, e.g. by using a separate drive, e.g. for putting the additional axle 6 completely out of service or adapting it to a specific pallet geometry.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A low-lift industrial truck, comprising a drive portion having a driving axle and a load-carrying portion which has two parallel wheel arms and is adjustable in height by means of a lifting device, wherein the wheel arms have load-carrying wheels in the free end region that are supported in rocker arms which, in turn, are coupled to the drive portion via a linkage so as to pivot the load-carrying wheels towards the underlying floor when the load-carrying portion is lifted, characterized in that the load-carrying portion (14), between the driving and load-carrying axles, has provided thereon an additional axle (6) on which the load-carrying portion rests when in a lowered, non-loaded condition while the load-carrying wheels (28) are largely relieved of loads or are lifted from the underlying floor.

2. The industrial truck according to claim 1, characterized in that the additional axle (6) is provided with at least one wheel (30) if there is a four-wheeled chassis.

3. The industrial truck according to claim 1, characterized in that the additional axle (6) has at least two wheels (30) if there is a three-wheeled or five-wheeled chassis.

4. The industrial truck according to claim 1, characterized in that the additional axle (6) is disposed near the drive portion (12).

5. The industrial truck according to claim 1, characterized in that the additional axle (6) is disposed approximately in the middle of the vehicle (14).

6. The industrial truck according to claim 1, characterized in that the additional axle is adjustable in height by means of an adjusting device.
